(19) United States
(12) Patent Application Publication
(10) Pub. No.: US 2001/0015766 A1
(43) Pub. Date: Aug. 23, 2001

(54) Enclosure for television cameras

(75) Inventor: Renzo Marchesini, Schio (IT)

Correspondence Address: MODIANO & ASSOCIATI, Via Meravigli, 16, Milano, 20123, IT

(73) Assignee: TEKNO SYSTEM S.r.1.

(21) Appl. No.: 09/780,689

(22) Filed: Feb. 7, 2001

(30) Foreign Application Priority Data
Feb. 22, 2000 (IT) PD2000U000012

(51) Int. Cl. H04N 5/225

(52) U.S. Cl. 348/373

(57) ABSTRACT

A television camera enclosure comprising a tubular outer container made of at least one metallic component and an internal hollow body which is made of plastics or other low-cost material and is suitable to contain at least one television camera.

### BACKGROUND OF THE INVENTION

The present invention relates to an improved enclosure for television cameras.

This type of enclosure is designed to protect television cameras of closed-circuit systems for monitoring, for example, environments such as banking institutions or in any case locations where visual monitoring of the premises is required.

In order to avoid any tampering with such television cameras, the enclosures must be made of sturdy materials and must have a shape whereby it is difficult for an ill-intentioned person to access the camera. Known types of television camera enclosures usually consist of a hollow body which contains the camera, is made of aluminum and is provided with an upper semitubular protective and covering element, also made of aluminum.

The above described type of enclosure, as well as other commercially available ones, which may also have different shapes, mostly have problems linked to the constructive complexity and high costs that arise from the use, for all their components, of a metallic material of a certain value such as aluminum, which moreover is not particularly versatile as regards machinability.

### SUMMARY OF THE INVENTION

The aim of the present invention is to solve or substantially reduce the problems of known types of television camera enclosures.

Within this aim, an important object of the present invention is to provide an enclosure for television cameras which is as flexible as possible from the functional point of view. Another object is to provide an enclosure by resorting to manufacturing processes which are simpler and more convenient than current ones.

Another object is to provide a television camera enclosure which is secure in terms of the possibility of being tampered with at least as much as known types.

Another object is to provide a television camera enclosure which is suitable both for indoor and outdoor environments.

This aim and these and other objects which will become better apparent hereinafter are achieved by a television camera enclosure, characterized in that it comprises a tubular outer container made of at least one metallic component and an internal hollow body which is made of plastics or other low-cost material and is suitable to contain at least one television camera.

Advantageously, such outer container is constituted by at least one extruded element made of metallic material and said hollow plastic body is obtained by molding.

### BRIEF DESCRIPTION OF THE DRAWINGS

Further characteristics and advantages of the invention will become better apparent from the following description of a preferred but not 1s exclusive embodiment of the invention, illustrated only by way of non-limitative example in the accompanying drawings, wherein:

FIG. 1 is a perspective view of an improved television camera enclosure according to the invention;

FIGS. 2 and 3 are respectively a partially sectional front view and a partially sectional side view of the enclosure of FIG. 1.

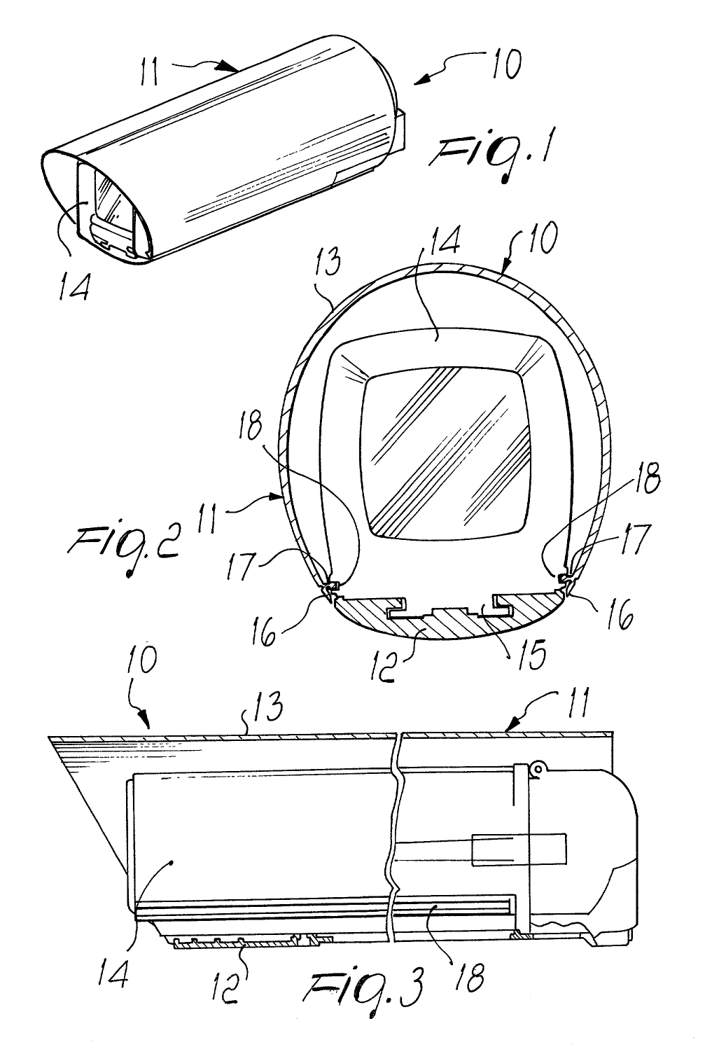

### DESCRIPTION OF THE PREFERRED EMBODIMENTS

With reference to the figures, an improved television camera enclosure according to the invention is generally designated by the reference numeral 10.

The enclosure is constituted by an outer container 11 which has a substantially cylindrical tubular cross-section.

The container 11 is in turn constituted by a longitudinal lower portion 12 which is obtained by molding and is separate from the remaining portion 13 obtained by extrusion.

As an alternative, it is possible to provide a single tubular component which integrates portions 12 and 13.

The lower portion 12 of the container 11 is shaped so as to provide, together with the corresponding portion of a box-like hollow body 14 arranged inside the container 11, a dovetail guide which is generally designated by the reference numeral 15.

The dovetail guide 15 is longitudinally elongated and allows to insert the hollow box-like body 14 in the container 11.

The box-like body 14 is obtained by molding plastics and is designed to accommodate a television camera, not shown in the figure.

As shown in FIGS. 2 and 3, the portion 13 of the container 11 has a substantially C-shaped cross-section, such as to almost completely surround the hollow box-like body 14.

At the longitudinal edges 16, the portion 13 is further provided with longitudinally elongated protrusions 17 which are coupled to corresponding is guides 18 provided in corresponding portions of the body 14.

The guides 18 and the dovetail guide 15 cooperate to the correct arrangement of the hollow body 14 inside the container 11.

In practice it has been observed that the present invention has achieved the intended aim and objects.

In particular, it can be noted that the hollow box-like body 14, being made of plastics, is of low-cost and highly workable.

The body 14 can thus be inserted in the aluminum container 11, which ensures the security of the television camera thanks to its protection characteristics.

Obviously the shape of the container 11 can be kept unchanged and bodies 14 different in shape can be provided.

In this manner it is possible to reduce the manufacturing costs of television camera enclosures by providing a single highly versatile one.

Finally, it is evident that this type of enclosure is particularly suitable both for indoor and outdoor environments.

The details may be replaced with other technically equivalent means.

The materials, so long as they are compatible with the contingent use, as well as the dimensions, may be any according to requirements. The disclosures in Italian Utility Model Application No. PD2000U000012 from which this application claims priority are incorporated herein by reference.

What is claimed is:

1. A television camera enclosure, comprising a tubular outer container made of metallic material, and an internal hollow body made of plastics or other low-cost material and adapted to contain at least one television camera.

2. The enclosure according to claim 1, wherein said outer container is constituted by at least one extruded element made of metallic material.

3. The enclosure according to claim 1, wherein said hollow body made of plastics is obtained by molding.

4. The enclosure according to claim 1, wherein said hollow body is shaped so as to define at least one longitudinal guide together with at least one corresponding portion of the outer container.

5. The enclosure according to claim 1, wherein said outer container is constituted by a longitudinal lower portion being separate from a remaining portion which has a substantially C-shaped cross-section, such as to fully surround said hollow body.

6. The enclosure according to claim 5, wherein said hollow body is shaped in a downward region so as to define a dovetail guide together with said longitudinal lower portion of the outer container.

7. The enclosure according to claim 5, wherein the portion of the outer container having a substantially C-shaped cross-section is provided, at longitudinal edges thereof, with longitudinally elongated protrusions which couple to corresponding guides provided in corresponding portions of said hollow body.
